(19) United States
(12) Patent Application Publication
(10) Pub. No.: US 2009/0046977 A1
(43) Pub. Date: Feb. 19, 2009

(54) WAVEGUIDE DEVICE AND OPTICAL NETWORK SYSTEM

(75) Inventors: Roshan Thapliya, Kanagawa (JP); Takashi Kikuchi, Kanagawa (JP); Shigetoshi Nakamura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/099,356

(22) Filed: Apr. 8, 2008

(30) Foreign Application Priority Data
Aug. 16, 2007 (JP) 2007-212254

(51) Int. Cl. G02B 6/28

(52) U.S. Cl. 385/23

(57) ABSTRACT

A waveguide device comprises a first multimode waveguide; a second multimode waveguide; a pair of intermediate single mode waveguides; an input-side single mode waveguides connected to the first multimode waveguide; a pair of output-side single mode waveguides connected to the second multimode waveguide; a pair of switching electrodes disposed to be superposed on the pair of intermediate single mode waveguides; and a ground electrode. The intermediate single mode waveguides are configured by a material whose refractive index is changed by voltages applied to the switching electrodes, the first multimode waveguide splits an optical signal into two signals whose intensities are equal, and the second multimode waveguide is formed, when voltages are not applied to the switching electrodes, to guide the optical signals out from the output-side single mode waveguides that are provided positions diagonal to the intermediate single mode waveguides through which the optical signals are propagated.

### CROSS-REFERENCE TO RELATED APPLICATION

This application is based on and claims priority under 35 USC 119 from Japanese Patent Application No. 2007-212254 filed on Aug. 16, 2007.

### BACKGROUND

1. Technical Field

The present invention relates to a waveguide device and an optical network system using the waveguide device.

2. Related Art

Optical couplers are an important part for configuring an optical network, but optical couplers that have been used in conventional optical networks are passive elements and can cause optical signals to split only by a certain ratio.

It is thought that in order to construct a more flexible optical network, optical couplers that can greatly change the ratio by which they split light are needed.

As such an optical splitting coupler, there is an optical switch called a Y-splitter switch, but this optical switch has the problem that, although its structure is simple, its allowable assembly accuracy is strict, and therefore its manufacturing efficiency is poor.

### SUMMARY

An aspect of the present invention is a waveguide device comprising a first multimode waveguide; a second multimode waveguide; a pair of intermediate single mode waveguides that interconnect the first multimode waveguide and the second multimode waveguide; an input-side single mode waveguides, that is connected to an end portion of the first multimode waveguide at a side opposite from a side to which the intermediate single mode waveguides are connected; a pair of output-side single mode waveguides that are connected to an end portion of the second multimode waveguide at a side opposite from a side to which the intermediate single mode waveguides are connected; a pair of switching electrodes that are disposed so as to be superposed on the pair of intermediate single mode waveguides; and a ground electrode that is disposed at a side opposite from a side at which the switching electrodes are disposed. The intermediate single mode waveguides are configured by a material having refractive index that is changed by voltages applied to the switching electrodes, the first multimode waveguide splits an optical signal guided in from the input-side single mode waveguide into two signals having equal intensities, and the second multimode waveguide is formed such that, when the voltages are not being applied to the switching electrodes, the second multimode waveguide guides optical signals propagated through the intermediate single mode waveguides out from the output-side single mode waveguides that are connected at positions diagonal to the intermediate single mode waveguides through which the optical signals are propagated

### BRIEF DESCRIPTION OF THE DRAWINGS

Exemplary embodiments of the present invention will be described in detail based on the following figures, wherein:

FIG. 1 is a perspective diagram showing the overall configuration of a waveguide device pertaining to embodiment 1;

FIG. 2 is a plan diagram showing the overall configuration of the waveguide device pertaining to embodiment 1;

FIG. 3A and FIG. 3B are cross-sectional diagrams showing cross sections of the waveguide device pertaining to embodiment 1 cut along a width direction;

FIG. 4 is an explanatory diagram showing the relative placement of waveguides in the waveguide device pertaining to embodiment 1;

FIG. 5 is a general explanatory diagram showing the flow of an optical signal in the waveguide device pertaining to embodiment 1;

FIG. 6 is a graph showing the relationship between voltages applied to switching electrodes in embodiment 1 and the intensities of emission light of a pair of output-side single mode waveguides with which the waveguide device is disposed;

FIG. 7 is a graph showing the relationship between voltages applied to the switching electrodes in embodiment 1 and the intensities of emission light of the pair of output-side single mode waveguides with which the waveguide device is disposed;

FIG. 8 is a graph showing a change in a drive voltage when the length of portions of intermediate single mode waveguides covered by the switching electrodes is changed in the waveguide device in embodiment 1;

FIG. 9 is a perspective diagram showing the overall configuration of a waveguide device pertaining to embodiment 2;

FIG. 10 is a plan diagram showing the overall configuration of the waveguide device pertaining to embodiment 2;

FIG. 11 is an explanatory diagram showing the relative placement of waveguides in the waveguide device pertaining to embodiment 2;

FIG. 12 is a general explanatory diagram showing the flows of optical signals in the waveguide device pertaining to embodiment 2;

FIG. 13 is a graph showing the relationship between voltages applied to switching electrodes in embodiment 2 and the intensities of emission light of a pair of output-side single mode waveguides with which the waveguide device is disposed;

FIG. 14 is a graph showing the relationship between voltages applied to the switching electrodes in embodiment 2 and the intensities of emission light of the pair of output-side single mode waveguides with which the waveguide device is disposed;

FIG. 15 is a graph showing a change in a drive voltage when the length of portions of intermediate single mode waveguides covered by the switching electrodes is changed in the waveguide device in embodiment 2;

FIG. 16 is a general diagram showing an example of an optical network system using the waveguide device pertaining to embodiment 1;

FIG. 17 is a general diagram showing an example of an optical network system using the waveguide device pertaining to embodiment 2; and

FIG. 18A to FIG. 18G are explanatory diagrams showing a process of manufacturing the waveguide devices pertaining to embodiments 1 and 2.

### DETAILED DESCRIPTION

Herebelow, examples of exemplary embodiments of the present invention will be described in detail with reference to the drawings.

### Embodiment 1

Below, an example of a waveguide device of the present invention will be described.

### (1) Configuration

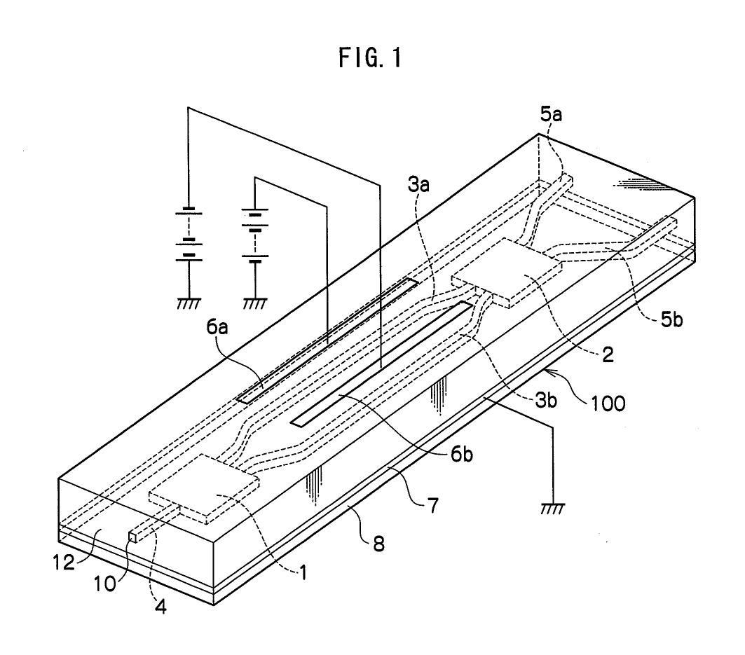

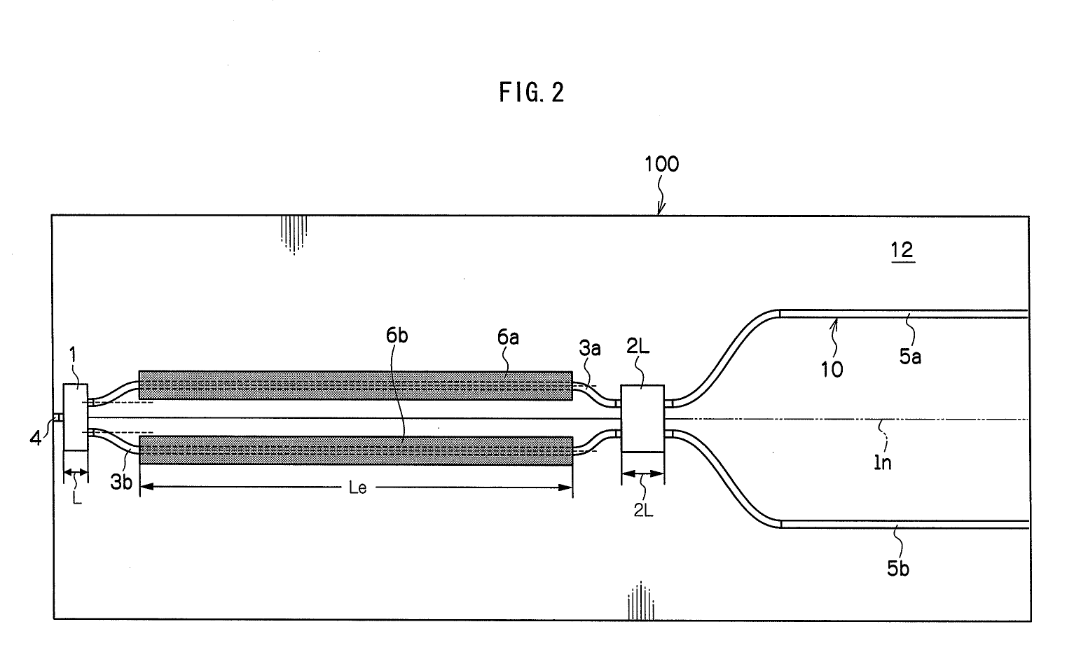

As shown in FIG. 1 and FIG. 2, a waveguide device 100 pertaining to embodiment 1 is disposed with a first multimode waveguide 1, a second multimode waveguide 2, intermediate single mode waveguides 3a and 3b that interconnect the first multimode waveguide 1 and the second multimode waveguide 2, an input-side single mode waveguide 4 that inputs an optical signal to the first multimode waveguide 1, a pair of output-side single mode waveguides 5a and 5b from which optical signals that have been guided into the second multimode waveguide 2 are emitted, switching electrodes 6a and 6b that are disposed so as to be superposed on the intermediate single mode waveguides 3a and 3b, and a ground electrode 7 that is positioned on the opposite side of the switching electrodes 6a and 6b with the intermediate single mode waveguides 3a and 3b being interposed therebetween. It will be noted that the ground electrode 7 is formed on a substrate 8.

One input-side single mode waveguide 4 is disposed, and the input-side single mode waveguide 4 is connected to a center portion of an input-side end portion of the first multimode waveguide 1 to which an optical signal is inputted.

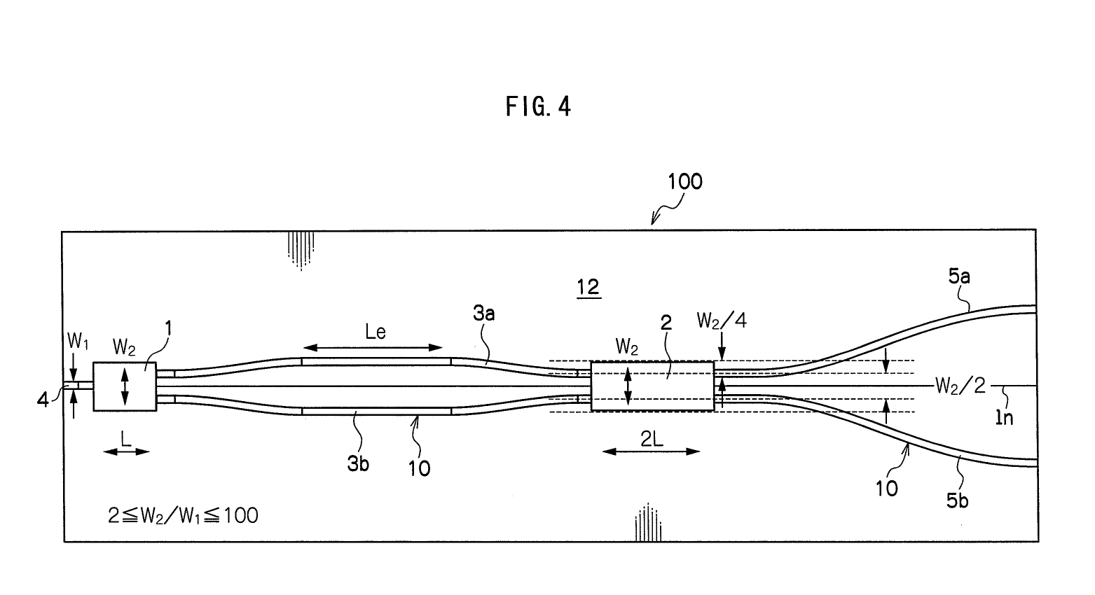

As shown in FIG. 2 and FIG. 4, both the intermediate single mode waveguides 3a and 3b and the output-side single mode waveguides 5a and 5b are formed and disposed substantially symmetrically with respect to a central axis ln along a longitudinal direction of the waveguide device 100.

The waveguide device 100 has a core and cladding structure configured by a core 10 and a cladding 12 that surrounds the core 10, and the first multimode waveguide 1, the second multimode waveguide 2, the intermediate single mode waveguides 3a and 3b, the input-side single mode waveguide 4 and the output-side single mode waveguides 5a and 5b are all formed integrally by the core 10.

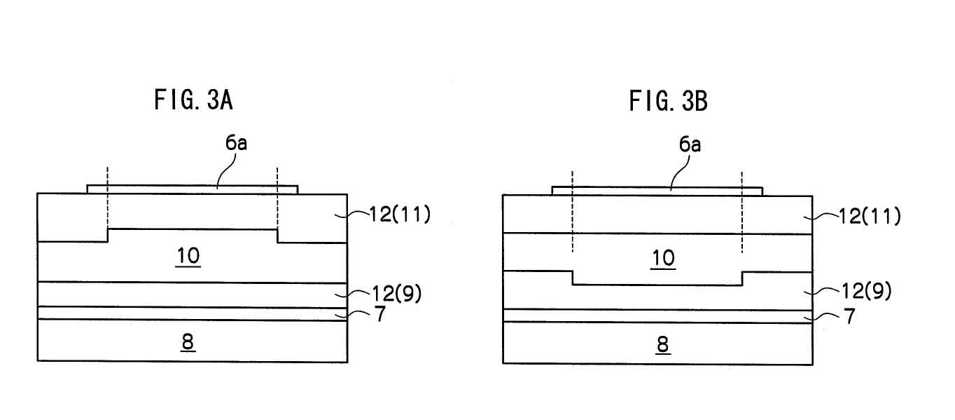

As shown in FIG. 3A, the core 10 may have a rib structure that projects in a rib-like manner upward, or as shown in FIG. 3B, the core 10 may have an inverted rib structure that projects in a rib-like manner downward.

By forming each of the input-side single mode waveguide 4, the first multimode waveguide 1, the intermediate single mode waveguides 3a and 3b, the second multimode waveguide 2 and the output-side single mode waveguides 5a and 5b to be a rib structure, a larger electric field arises in the core layer 10—specifically, the intermediate single mode waveguides 3a and 3b—with voltages applied to the switching electrodes 6a and 6b thereby, switching operation can be performed with a lower drive voltage.

It will be noted that when, for whatever reason, the core 10 cannot be etched to form the input-side single mode waveguide 4, the first multimode waveguide 1, the intermediate single mode waveguides 3a and 3b, the second multimode waveguide 2 and the output-side single mode waveguides 5a and 5b, a lower cladding layer 9 of the cladding 12 may be etched into a predetermined shape, and a forming solution for forming the core 10 may then be provided, heated and allowed to harden, whereby these light paths can be formed as waveguides with an inverted rib structure.

As shown in FIG. 4, each of the cores of the input-side single mode waveguide 4, the intermediate single mode waveguides 3a and 3b and the output-side single mode waveguides 5a and 5b has a same width W₁. Additionally, it is preferable for a width W₂ of the first multimode waveguide 1 and the second multimode waveguide 2 to satisfy the relational expression 2≦W₂/W₁≦100 for safely performing multimode transmission in the first multimode waveguide 1 and the second multimode waveguide 2.

The first multimode waveguide 1 and the second multimode waveguide 2 have a length L and a length 2L, respectively. The length L of the first multimode waveguide 1 can be set as a function of a difference Δn between a refractive index n₂ of the cladding 12 and a refractive index n₁ of the core 10, the width W₁ of the input-side single mode waveguide 4, the intermediate single mode waveguides 3a and 3b and the output-side single mode waveguides 5a and 5b, and the width W₂ of the first multimode waveguide 1 and the second multimode waveguide 2. Specifically, L is inversely proportional to W₂ and Δn, and is proportional to the square of W₁.

As shown in FIG. 4, the intermediate single mode waveguides 3a and 3b are disposed such that, at both end portions thereof respectively connected to the first multimode waveguide 1 and the second multimode waveguide 2, the distance between centerlines of their cores is W₂/2 or about W₂/2 and the respective distance from the side edges of the first multimode waveguide 1 and the second multimode waveguide 2 to the centerlines is W₂/4 or about W₂/4. This is the same in regard also to the output-side single mode waveguides 5a and 5b: the output-side single mode waveguides 5a and 5b are disposed such that, at portions thereof connected to the second multimode waveguide 2, the distance between centerlines of their cores is W₂/2 or about W₂/2 and the respective distance from the side edges of the second multimode waveguide 2 to the centerlines is W₂/4 or about W₂/4. Additionally, the intermediate single mode waveguides 3a and 3b curve in the vicinities of both of their end portions such that their center portions are formed in straight lines and such that the distance between them becomes relatively wider in comparison to the distance between both end portions. This is the same in regard also to the output-side single mode waveguides 5a and 5b: the output-side single mode waveguides 5a and 5b curve such that the distance between them widens away from the second multimode waveguide 2.

As shown in FIG. 2, the switching electrodes 6a and 6b are formed so as to be superposed on the intermediate portions of the intermediate single mode waveguides 3a and 3b that are formed in straight lines. The ground electrode 7 is grounded, a positive voltage is applied to one of the switching electrodes 6a and 6b, and a negative voltage is applied to the other of the switching electrodes 6a and 6b.

Any material can be used for the core 10 and the cladding 12 as long as it is a material that has an electro-optical effect where its refractive index changes when an electric field is applied thereto and is transparent with respect to light to be modulated, such as a translucent polymer material such as an acrylic resin or an epoxy resin, a polyethylene terephthalate resin, a polycarbonate resin, a polyurethane resin, a polyimide resin, a fluorinated polyimide resin, a polyetherimide resin, a polysulfone resin, a polyethersulfone resin, a polyacrylate resin, and a polysiloxane resin, silicon oxide, various types of glass, strontium titanate, gallium arsenide, and indium phosphorus. It will be noted that when the above translucent polymer is used, a nonlinear optical effect is manifested, so it is preferable to disperse a pigment having an electro-optical effect or to join a base having a nonlinear optical effect to the main chain or the side chain.

Examples of materials that may be used for the switching electrodes 6a and 6b and the ground electrode 7 include various types of metal materials and metal oxides known as materials for electrodes, such as aluminium, titanium, gold, copper, and ITO.

### (2) Manufacturing Process

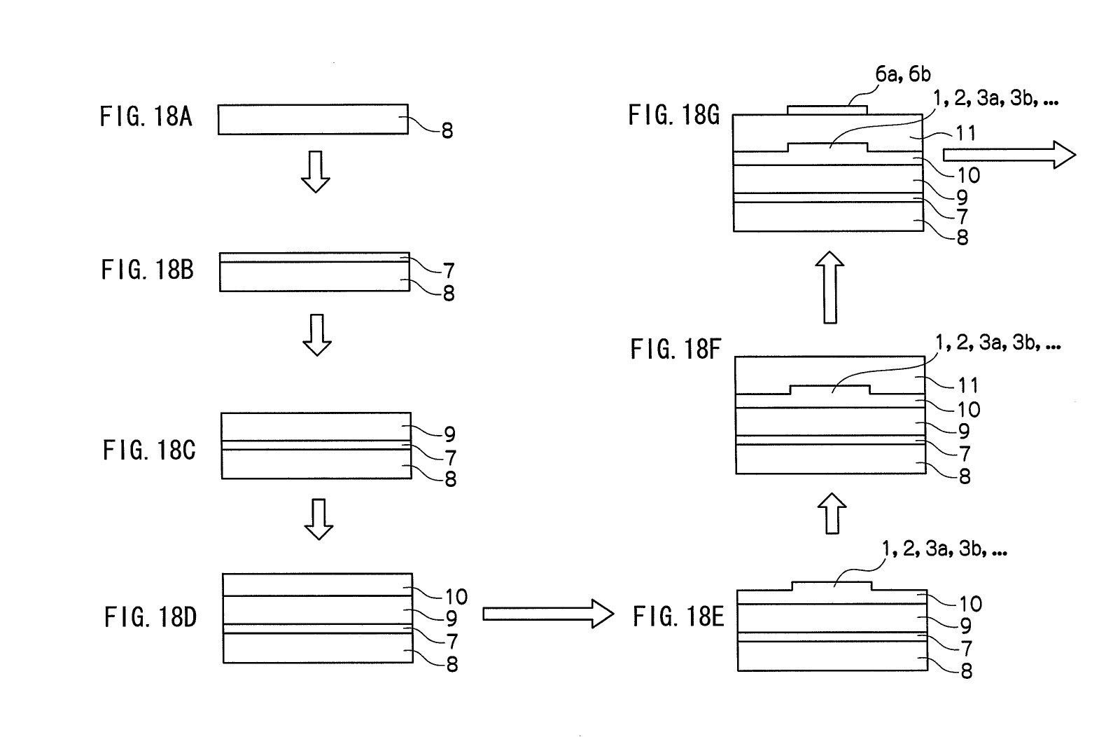

The waveguide device 100 can be manufactured by the process shown in FIG. 18A to FIG. 18G.

First, as shown in FIG. 18A, the substrate 8 is prepared. As the substrate 8, it is possible to use any substrate such as a glass substrate, a quartz substrate, a silicon substrate, or a polyimide substrate. By applying a silane coupling agent or the like to the substrate 8, adhesiveness with the ground electrode 7 can be improved.

Next, as shown in FIG. 18B, the ground electrode 7 is formed on the surface of the substrate 8. The ground electrode 7 may be formed by depositing or plating a metal such as aluminium, titanium, gold or copper on the surface of the substrate 8, or a foil of the above metal may be adhered to the surface of the substrate 8.

When the ground electrode 7 is formed, as shown in FIG. 18C, the lower cladding layer 9 is formed on the surface of the ground electrode 7. First, a solution of a translucent polymer that forms the lower cladding layer 9 is applied to the surface of the ground electrode 7. Examples of the method of applying the above solution to the ground electrode 7 include curtain coating, extrusion molding coating, roll coating, spin coating, dip coating, bar coating, spray coating, slide coating, and print coating. When the solution of the above material is applied to the substrate, it is heated and the solvent is removed, then it is allowed to react and harden as needed, and the lower cladding layer 9 is formed.

Next, as shown in FIG. 18D, a layer of the core 10 is formed on the surface of the lower cladding layer 9. The layer of the core 10 can be formed, for example, by applying a solution of a translucent polymer that forms the core 10 to the surface of the lower cladding layer 9, heating it, and allowing it to harden. The same methods as those described in regard to the lower cladding layer 9 can be used as the method of applying the solution.

When the layer of the core 10 is formed, as shown in FIG. 18E, the waveguides such as the incident-side single mode waveguide 4, the first multimode waveguide 1 and the intermediate single mode waveguides 3a and 3b are formed in the core 10. Examples of means for forming the waveguides include etching or the like. Further, the above waveguides may also be made by forming, in the lower cladding layer 9, recessed portions having shapes corresponding to the above waveguides, applying a solution of a translucent polymer from above, heating it, and allowing it to harden.

Next, as shown in FIG. 18F, an upper cladding layer 11 is formed on the layer of the core 10, and an electric field is applied in a thickness direction of the layer of the core 10 to perform a polarization orientation treatment. The cladding 12 is formed by the lower cladding layer 9 and the upper cladding layer 11.

When the polarization orientation treatment ends, as shown in FIG. 18G, the switching electrodes 6a and 6b are formed on the surface of the upper cladding layer 11. In this manner, the waveguide device 100 can be formed.

### (3) Function

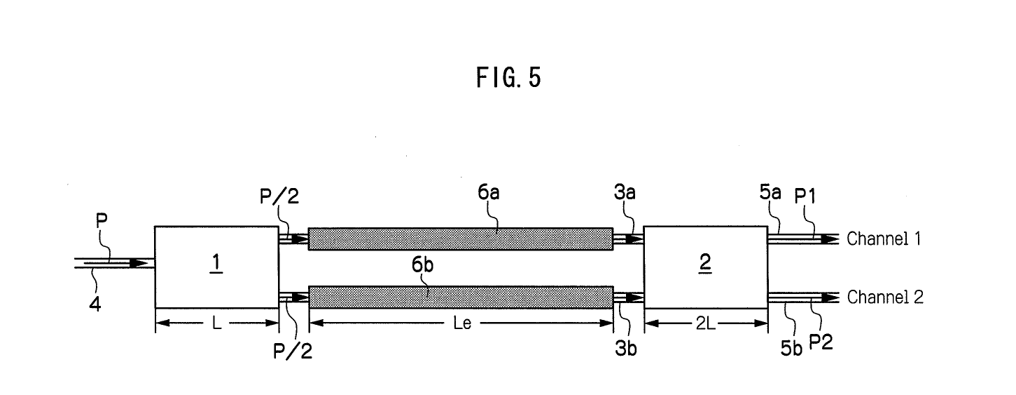

The function of the waveguide device 100 will be described below. As shown in FIG. 5, an optical signal of an intensity P made incident from the incident-side single mode waveguide 4 is split into two optical signals of intensities P/2 by the first multimode waveguide 1. The optical signals that have been split into two are made incident in the intermediate single mode waveguides 3a and 3b, respectively. Additionally, the optical signals propagate through the intermediate single mode waveguides 3a and 3b are made incident in the second multimode waveguide 2.

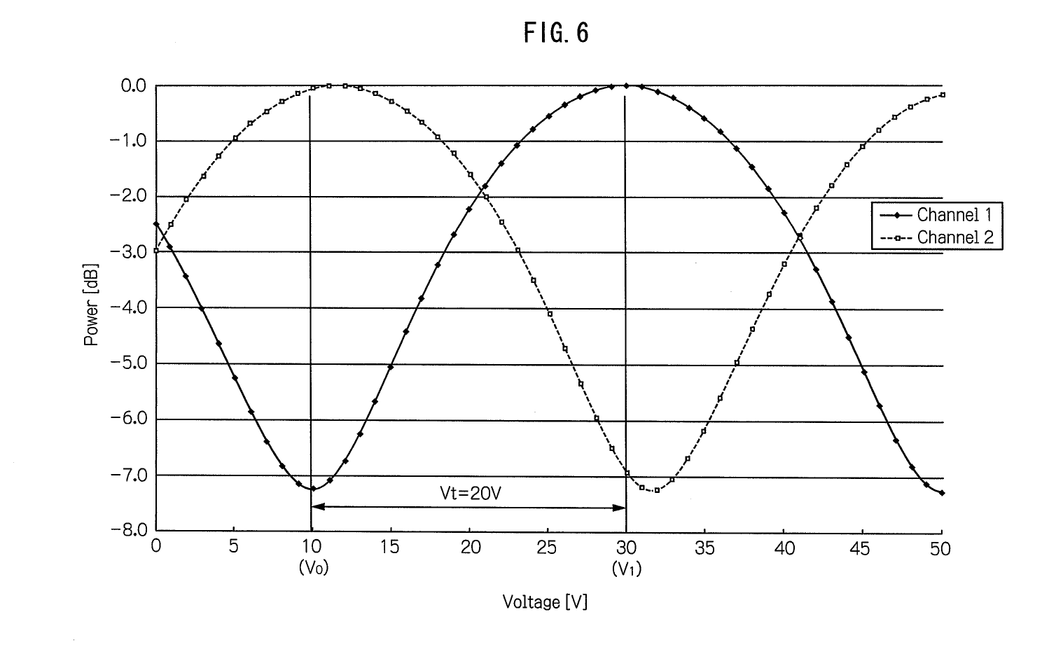

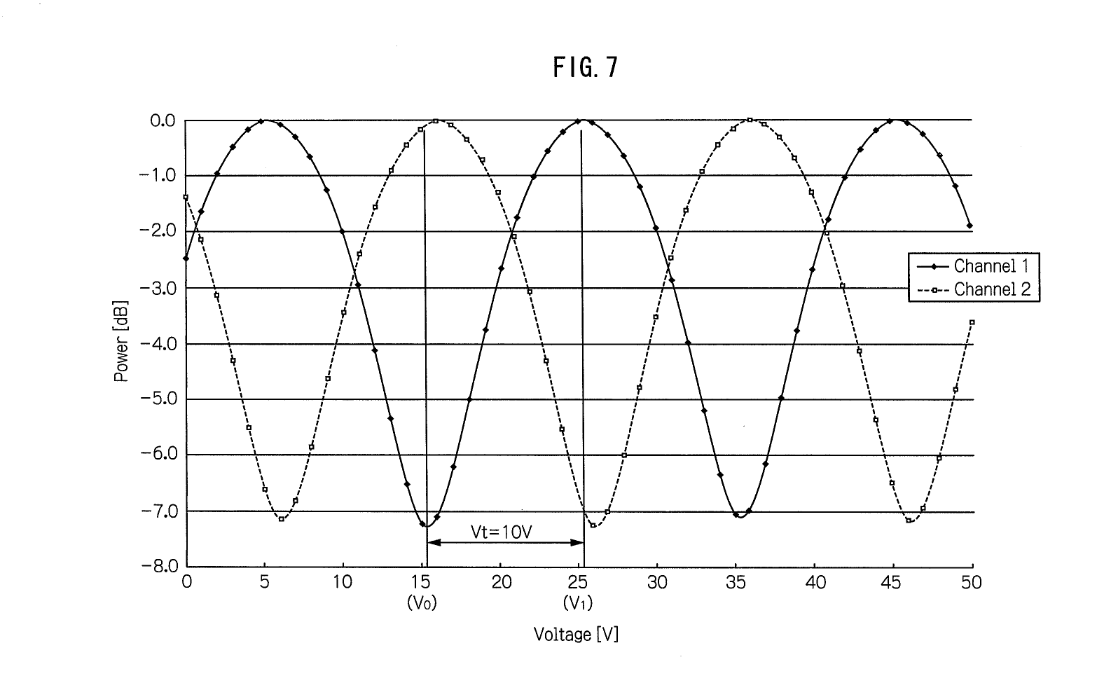

When voltages are not applied to the switching electrodes 6a and 6b, the refractive indexes of the intermediate single mode waveguides 3a and 3b are equal to the refractive index n, of the core 10 therefore, the two optical signals propagate with the same phase respectively through the intermediate single mode waveguides 3a and 3b. Additionally, because the second multimode waveguide 2 has the length 2L and the first multimode waveguide 1 has the length L, the optical signals of the intensities P/2 that have propagated through the intermediate single mode waveguides 3a and 3b are recombined into an optical signal of the intensity P by the second multimode waveguide 2 and are thereafter again split into two optical signals of the intensities P/2. Then, the optical signals are emitted from the output-side single mode waveguides 5a and 5b, respectively. Consequently, in this case, as shown in FIG. 6 and FIG. 7, the intensity P1 of the optical signal emitted from the output-side single mode waveguide 5a—that is, channel 1—and the intensity P2 of the optical signal outputted from the output-side single mode waveguide 5b—that is, channel 2—are both P/2 and equal.

Next, when a positive voltage is applied to the switching electrode 6a and a negative voltage is applied to the switching electrode 6b, the refractive index of one of the intermediate single mode waveguides 3a and 3b becomes larger than n, and the refractive index of the other becomes smaller than n₁. Consequently, both phase of the optical signals propagating through the intermediate single mode waveguide 3a and the intermediate single mode waveguide 3b change. The position of a luminescent spot formed as a result of the optical signals interfering inside the second multimode waveguide 2 also moves in comparison to when voltages are not applied to the switching electrodes 6a and 6b. Thus, as shown in FIG. 6 and FIG. 7, the intensity P1 of the optical signal emitted from the output-side single mode waveguide 5a (channel 1) increases, and the intensity P2 of the optical signal emitted from the output-side single mode waveguide 5b (channel 2) decreases. Additionally, when the voltage applied to the switching electrode 6a becomes +V₀ (V) and the voltage applied to the switching electrode 6b becomes −V₀ (V), the intensity P2 of the optical signal from channel 2 becomes virtually 0, and the intensity P1 of the optical signal from channel 1 reaches a maximum.

Then, when the absolute values of the voltages applied to the switching electrodes 6a and 6b are further increased from V₀, as shown in FIG. 6 and FIG. 7, the intensity P2 of the optical signal from channel 2 begins to increase from 0, and the intensity P1 of the optical signal from channel 1 begins to decrease from the maximum value. Then, when the voltage applied to the switching electrode 6a becomes +V₁ (V) and the voltage applied to the switching electrode 6b becomes −V₁ (V), the intensity P2 of the optical signal from channel 2 reaches a maximum value, and conversely the intensity P1 of the optical signal from channel 1 decreases virtually to 0.

In this manner, in the waveguide device 100, by applying voltages of mutually opposite polarities to the switching electrodes 6a and 6b and controlling the absolute values of the voltages, an optical signal can be selectively emitted from either channel 1 or channel 2 so that the waveguide device 100 functions as an optical switch.

### Embodiment 2

### (1) Configuration and Manufacturing Process

Another example of the waveguide device pertaining to the present invention will be described below.

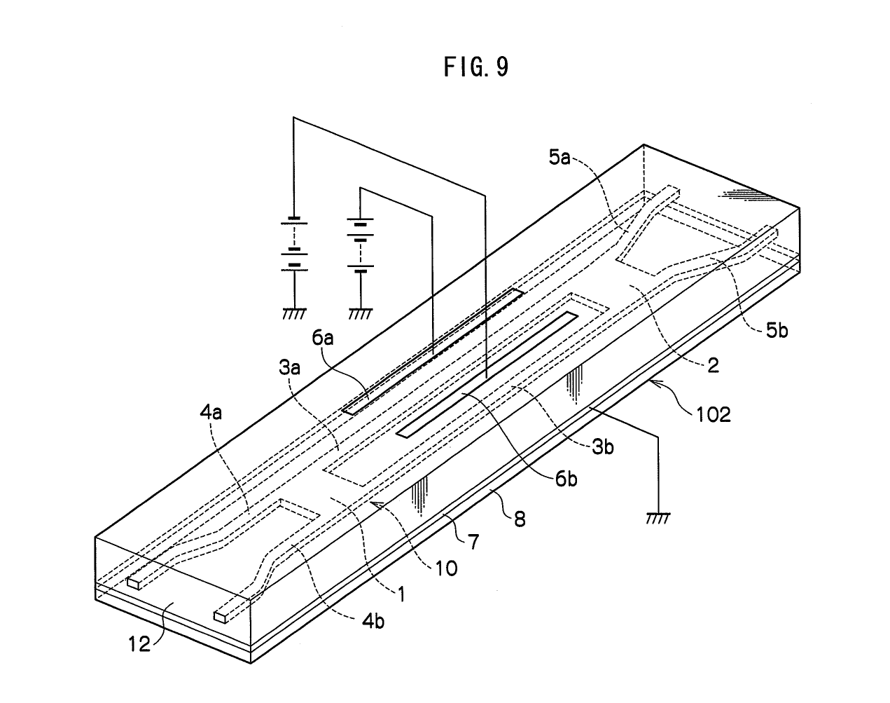

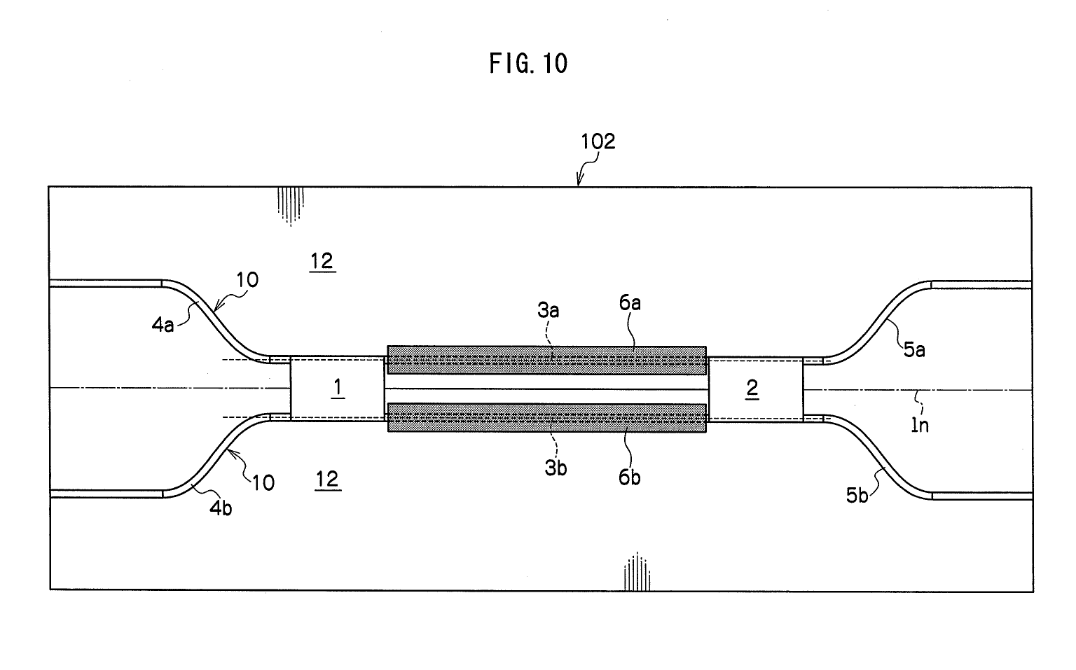

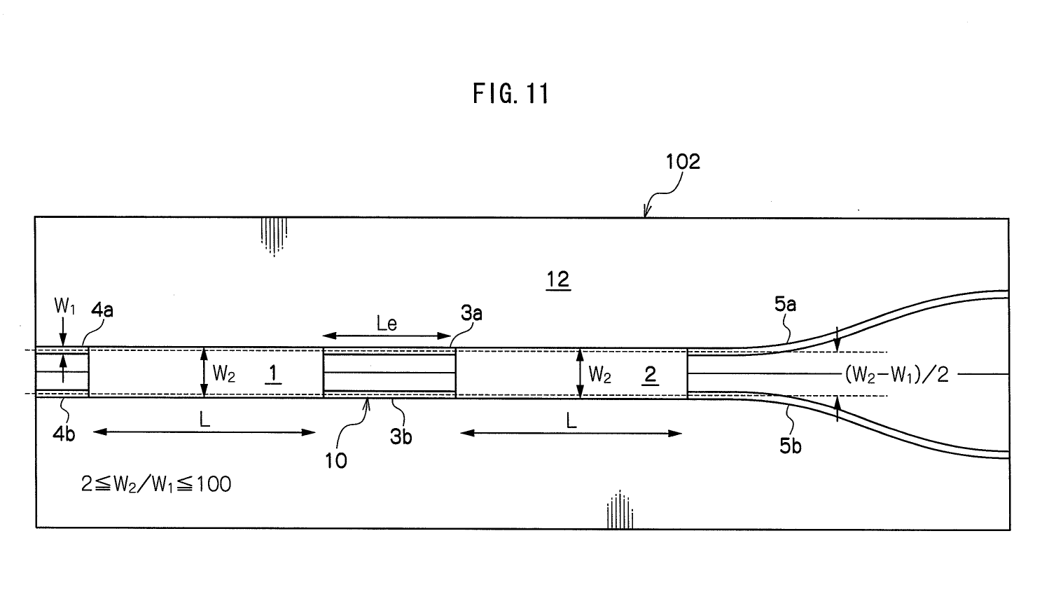

As shown in FIG. 9 to FIG. 11, in a waveguide device 102 pertaining to embodiment 2, two of the input-side single mode waveguides 4 are disposed. An input-side single mode waveguide 4a is connected in the vicinity of one of the pair of side edges along the longitudinal direction of the first multimode waveguide 1 and an input-side single mode waveguide 4b is connected to the other of the side edges of the first multimode waveguide 1.

In the waveguide device 102, the first multimode waveguide 1 and the second multimode waveguide 2 have not only the same width W₂ but also the same length L. Additionally, the intermediate single mode waveguides 3a and 3b and the output-side single mode waveguides 5a and 5b are both connected in the vicinity of the pair of side edges of the first multimode waveguide 1 and the second multimode waveguide 2 along the longitudinal direction.

The length L of the first multimode waveguide 1 and the second multimode waveguide 2 can be set as a function of the difference Δn between the refractive index n₂ of the cladding 12 and the refractive index n₁ of the core 10, the width W₁ of each core of the input-side single mode waveguides 4a and 4b, the intermediate single mode waveguides 3a and 3b and the output-side single mode waveguides 5a and 5b, and the width W₂ of the first multimode waveguide 1 and the second multimode waveguide 2. In regard to the relationship of L with respect to Δn, W₁ and W₂, it is as has been described in embodiment 1.

With the exception of the above-described points, the waveguide device 102 has the same configuration as that of the waveguide device 100 pertaining to embodiment 1.

Further, the manufacturing process is as shown in FIG. 18A to FIG. 18G

### (2) Function

The function of the waveguide device 102 will be described below.

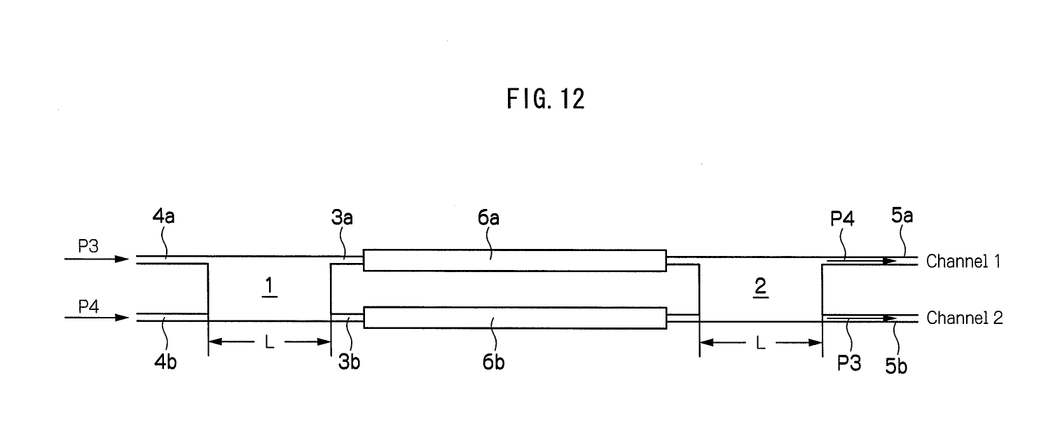

An optical signal P3 made incident from the incident-side single mode waveguide 4a is split into two optical signals having the same intensity by the first multimode waveguide 1, and these two optical signals are made incident in the intermediate single mode waveguides 3a and 3b, respectively. The optical signals P3 that have been split by the first multimode waveguide 1 propagate through the intermediate single mode waveguides 3a and 3b and are recombined by the second multimode waveguide 2. Here, when voltages are not applied to the switching electrodes 6a and 6b, the optical signals P3 propagate with the same phase respectively through the intermediate single mode waveguides 3a and 3b, but because the length L of the second multimode waveguide 2 is equal to that of the first multimode waveguide 1, as shown in FIG. 12, the optical signal P3 that has been recombined by the second multimode waveguide 2 is emitted from the output-side single mode waveguide 5b—that is, channel 2—that is a position diagonal to the input-side single mode waveguide 4a.

Similarly, an optical signal P4 made incident from the incident-side single mode waveguide 4b is emitted from the output-side single mode waveguide 5a—that is, channel 2—that is a position diagonal to the input-side single mode waveguide 4b.

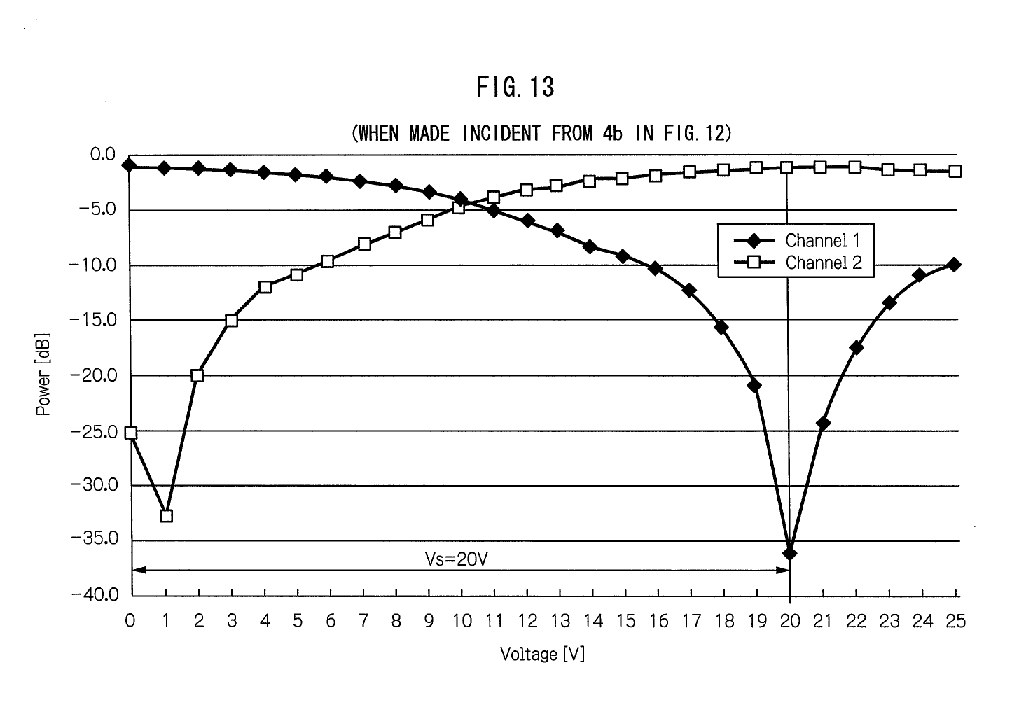

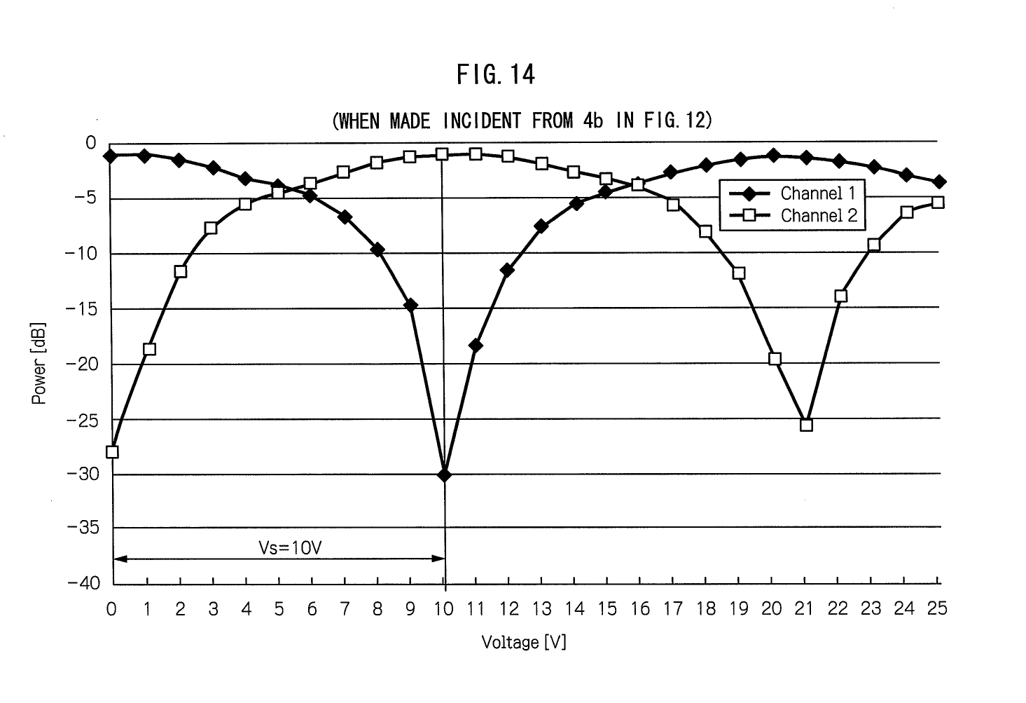

Here, when a positive voltage is applied to the switching electrode 6a and a negative voltage is applied to the switching electrode 6b, the refractive index of one of the intermediate single mode waveguides 3a and 3b becomes larger than n₁ that is the refractive index of core 10 and the refractive index of the other becomes smaller than n₁. Consequently, the phase of the optical signal propagating through the intermediate single mode waveguide 3a and the phase of the optical signal propagating through the intermediate single mode waveguide 3b both change, so the position of a luminescent spot formed as a result of the optical signals interfering inside the second multimode waveguide 2 also moves in comparison to when voltages are not applied to the switching electrodes 6a and 6b. Thus, as shown in FIG. 13 and FIG. 14, the intensity of the optical signal emitted from the output-side single mode waveguide 5a (channel 1) increases, and the intensity of the optical signal emitted from the output-side single mode waveguide 5b(channel 2) decreases. Additionally, when the voltage applied to the switching electrode 6a reaches +V_{S} (V) and the voltage applied to the switching electrode 6b becomes −V_{S} (V), the intensity of the optical signal from channel 1 reaches a maximum and the intensity of the optical signal from channel 2 becomes virtually zero. Consequently, the optical signal P3 made incident from the input-side single mode waveguide 4a is emitted from the output-side single mode waveguide 5a (channel 1).

Similarly, the optical signal P4 made incident from the input-side single mode waveguide 4b is emitted from the output-side single mode waveguide 5b (channel 2).

In this manner, in the waveguide device 102, by applying voltages to the switching electrodes 6a and 6b, the output destinations of the optical signals made incident from the input-side single mode waveguides 4a and 4b can be switched.

### Embodiment 3

An optical network system using the waveguide device 100 pertaining to embodiment 1 will be described below.

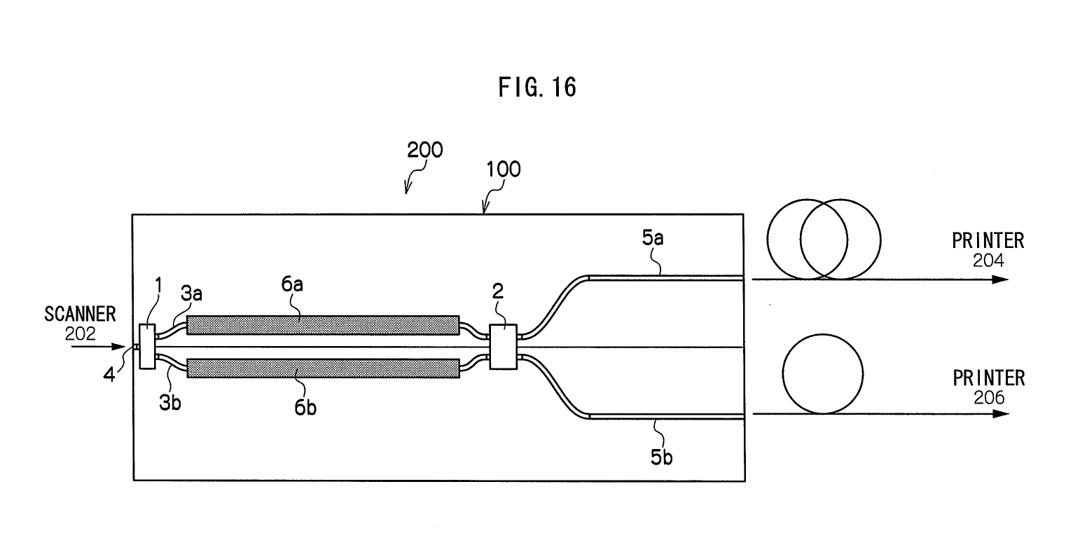

As shown in FIG. 16, an optical network system 200 pertaining to embodiment 3 is configured by the waveguide device 100, a scanner 202 that is connected to the input-side single mode waveguide 4 of the waveguide device 100, a printer 204 that is connected to the output-side single mode waveguide 5a of the waveguide device 100, a printer 206 that is connected to the output-side single mode waveguide 5b, and a voltage applying circuit (not shown) that applies voltages to the switching electrodes 6a and 6b of the waveguide device 100.

In the optical network system 200, by changing, in the voltage applying circuit, the voltages applied to the switching electrodes 6a and 6b between ±V₀ (V) and ±V₁ (V), the output from the scanner 202 can be emitted from the output-side single mode waveguide 5a of the waveguide device 100 or from the output-side single mode waveguide 5b, so an image read by the scanner 202 can be printed by the printer 204 or by the printer 206.

### Embodiment 4

An optical network system using the waveguide device 102 pertaining to embodiment 2 will be described below.

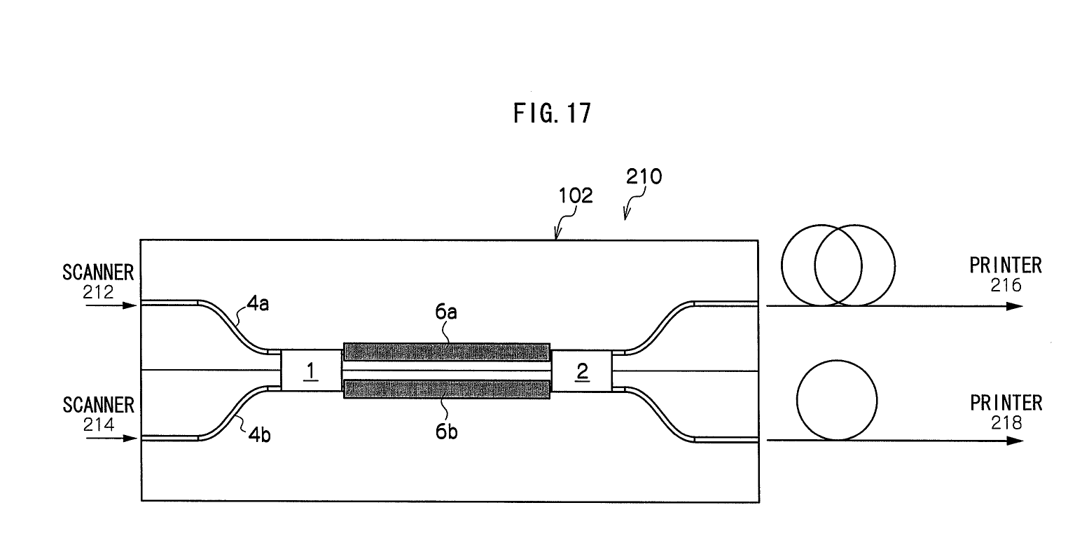

As shown in FIG. 17, an optical network system 210 pertaining to embodiment 4 is configured by the waveguide device 102, a scanner 212 that is connected to the input-side single mode waveguide 4a of the waveguide device 102, a scanner 214 that is connected to the input-side single mode waveguide 4b, a printer 216 that is connected to the output-side single mode waveguide 5a of the waveguide device 102, a printer 218 that is connected to the output-side single mode waveguide 5b, and a voltage applying circuit (not shown) that applies voltages to the switching electrodes 6a and 6b of the waveguide device 102.

In the optical network system 210, by changing the voltages applied to the switching electrodes 6a and 6b between 0 and ±V_{S} (V), the output from the scanners 212 and 214 can be emitted from the output-side single mode waveguide 5a of the waveguide device 102 or from the output-side single mode waveguide 5b, so images read by the scanners 212 and 214 can be selectively printed by either the printer 216 or the printer 218.

### EXAMPLES

### Example 1

The waveguide device 100 pertaining to embodiment 1 was manufactured in accordance with the process shown in FIG. 18A to FIG. 18G.

Gold was deposited by VCD on the substrate 8 made of quartz glass to form the ground electrode 7, and an acrylic resin was spin-coated thereon and hardened by ultraviolet light to form the lower cladding layer 9 with a thickness of 4 μm.

Then, a material in which Disperse-Red 1 was dispersed in FTC (2-dicyanomethylene-3-cyano-4-{2-[trans-(4-N,N-diacetoxyethyl-amino) phenylene-3,4-dibutylene-5]vinyl}-5,5-dimethyl-2,5-dihydrofuran) was spin-coated on the lower cladding layer 9, heated and allowed to harden to form the layer of the core 10 with a thickness of 3.3 μm.

Next, the layer of the core 10 was etched to form the incident-side single mode waveguide 4, the first multimode waveguide 1, the intermediate single mode waveguides 3a and 3b, the second multimode waveguide 2 and the output-side single mode waveguides 5a and 5b. The width W₁ of the incident-side single mode waveguide 4, the intermediate single mode waveguides 3a and 3b and the output-side single mode waveguides 5a and 5b was 5 μm, and the width W₂ of the first multimode waveguide 1 and the second multimode waveguide 2 was 40 μm. Consequently, W₂/W₁=8. The distance between the centerlines of the incident-side single mode waveguide 4, the intermediate single mode waveguides 3a and 3b and the output-side single mode waveguides 5a and 5b was set to 15 μm.

In the first multimode waveguide 1, the length L was set to 1035 μm, and in the second multimode waveguide 2, the length 2L was set to 2070 μm. In the intermediate single mode waveguides 3a and 3b, the length of the portions in the vicinities of the first multimode waveguide 1 and the second multimode waveguide 2 that were not covered by the switching electrodes 6a and 6b was 2000 μm, and the length of the intermediary portions covered by the switching electrodes 6a and 6b was changed between 0.05 cm and 2 cm.

When the incident-side single mode waveguide 4, the first multimode waveguide 1, the intermediate single mode waveguides 3a and 3b, the second multimode waveguide 2 and the output-side single mode waveguides 5a and 5b were formed at the core layer 10, the same acrylic resin as was used to form the lower cladding layer 9 was spin-coated thereon to a thickness of 4 μm and allowed to harden by ultraviolet light. The refractive indexes of the lower cladding layer 9 and the upper cladding layer 11 were 1.5437, and the refractive index of the layer of the core 10 was 1.6563.

When the upper cladding layer 11 was formed, gold was deposited thereon to form source electrodes. When the source electrodes were formed, a voltage of 400 to 2000 V was applied between the ground electrode 7 and the source electrode at a high temperature of 90 to 250° C., it was left to cool to room temperature in the state where the above voltage was applied, and the core 10 was subjected a polarization orientation treatment.

When the polarization orientation treatment ended, the source electrodes were etched and removed, the switching electrodes 6a and 6b with a width of 10 μm were formed by gold-plating, and the waveguide device 100 was manufactured. The length of the switching electrodes 6a and 6b was changed from 0.05 cm to 2 cm in accordance with the length of the intermediate single mode waveguides 3a and 3b.

In regard to the waveguide device 100 that had been manufactured, an optical signal of an intensity of 0 dB was guided into the input-side single mode waveguide 4, the voltages applied to the switching electrodes 6a and 6b were respectively increased from 0 to ±50 V, and the intensities of the optical signals emitted from the output-side single mode waveguides 5a and 5b were measured. The results thereof are shown in FIG. 6 and FIG. 7.

In the case where the length Le of the portions of the intermediate single mode waveguides 3a and 3b covered by the switching electrodes 6a and 6b was 0.25 cm, as shown in FIG. 6, when the voltages applied to the switching electrodes 6a and 6b were 0 (V), the intensities of the optical signals emitted from the output-side single mode waveguides 5a and 5b were about −3 dB and substantially equal, but when the voltage applied to the switching electrode 6a was increased to +10 V and the voltage applied to the switching electrode 6b was increased to −10 (V) (below, called “increasing the voltages applied to the switching electrodes 6a and 6b by ±10V”), the intensity of the optical signal emitted from the output-side single mode waveguide 5b increased to almost 0 dB, but the intensity of the optical signal emitted from the output-side single mode waveguide 5a decreased to −7.0 dB.

Moreover, when the voltages applied to the switching electrodes 6a and 6b were increased, this time the intensity of the optical signal emitted from the output-side single mode waveguide 5b began to decrease from 0 dB and the intensity of the optical signal emitted from the output-side single mode waveguide 5a began to increase from −7.0 dB. Then, when the voltages applied to the switching electrodes 6a and 6b reached ±30 V, the intensity of the optical signal emitted from the output-side single mode waveguide 5b decreased to −7.0 dB, while the intensity of the optical signal emitted from the output-side single mode waveguide 5a increased to 0 dB.

Consequently, it was understood that, in the case where the length Le of the portions of the intermediate single mode waveguides 3a and 3b covered by the switching electrodes 6a and 6b was 0.25 cm, the drive voltage was 30−10=20 (V).

In the case where the length Le of the portions of the intermediate single mode waveguides 3a and 3b covered by the switching electrodes 6a and 6b was 0.5 cm, as shown in FIG. 7, when the voltages applied to the switching electrodes 6a and 6b were 0 (V), the intensities of the optical signals emitted from the output-side single mode waveguides 5a and 5b were about −3 dB and substantially equal, but when the voltages applied to the switching electrodes 6a and 6b were increased to ±5 (V), the intensity of the optical signal emitted from the output-side single mode waveguide 5a increased to almost 0 dB, but the intensity of the optical signal emitted from the output-side single mode waveguide 5b decreased to −7.0 dB.

Moreover, when the voltages applied to the switching electrodes 6a and 6b were increased, this time the intensity of the optical signal emitted from the output-side single mode waveguide 5a began to decrease from 0 dB and the intensity of the optical signal emitted from the output-side single mode waveguide 5b began to increase from −7.0 dB. Then, when the voltages applied to the switching electrodes 6a and 6b reached ±15 V, the intensity of the optical signal emitted from the output-side single mode waveguide 5a decreased to −7.0 dB, but the intensity of the optical signal emitted from the output-side single mode waveguide 5b increased to 0 dB.

Consequently, it was understood that, in the case where the length Le of the portions of the intermediate single mode waveguides 3a and 3b covered by the switching electrodes 6a and 6b was 0.5 cm, the drive voltage was 15−5=10 (V).

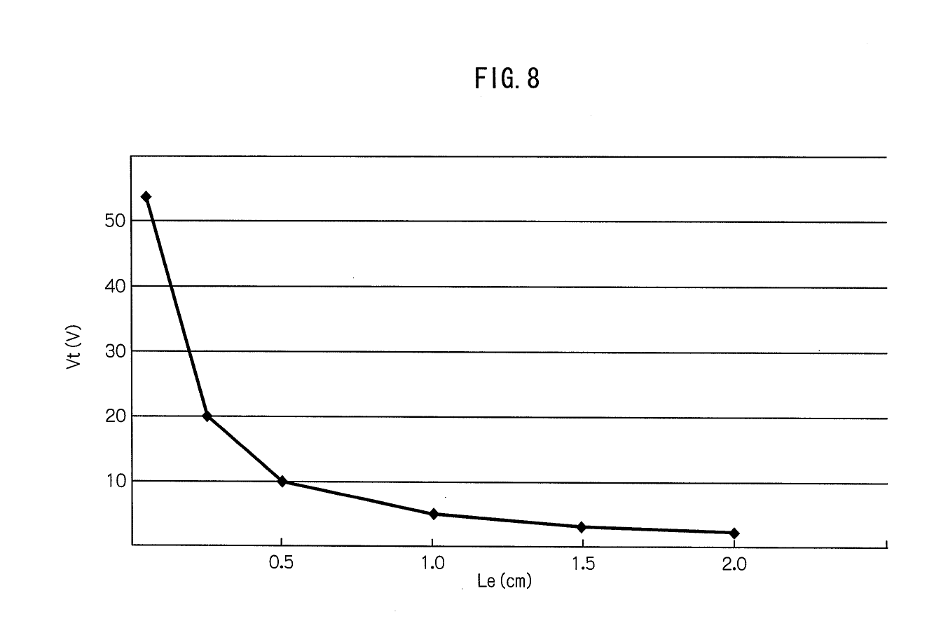

In this manner, in the waveguide device 100, it was understood that the drive voltage became lower when the length Le of the portions of the intermediate single mode waveguides 3a and 3b covered by the switching electrodes 6a and 6b was 0.5 cm in comparison to when the length Le was 0.25 cm. The variation in the drive voltage when the length Le was changed is shown in FIG. 8. As will be understood from FIG. 8, the drive voltage dropped the longer the length Le was. Specifically, when the length Le was 2 cm, the drive voltage was only 2 V.

### Example 2

The waveguide device 102 pertaining to embodiment 2 was manufactured. In regard to the process, the thickness and the materials of the lower cladding layer 9, the layer of the core 10 and the upper cladding layer 11, these were as was described in example 1. It will be noted that, similar to example 1, in regard to the intermediate single mode waveguides 3a and 3b, the length of the portions in the vicinities of the first multimode waveguide 1 and the second multimode waveguide 2 that were not covered by the switching electrodes 6a and 6b was 2000 μm, and the length of the intermediary portions covered by the switching electrodes 6a and 6b was changed between 0.05 cm and 2 cm. Additionally, the length of the switching electrodes 6a and 6b was changed between 0.05 cm and 2 cm in accordance with the length of the intermediate single mode waveguides 3a and 3b.

In regard to the waveguide device 102 that had been manufactured, optical signals of intensities of 0 dB were guided into the input-side single mode waveguides 4a and 4b, the voltages applied to the switching electrodes 6a and 6b were increased from 0 to ±25 V, and the intensities of the optical signals emitted from the output-side single mode waveguides 5a and 5b were measured. The results thereof are shown in FIG. 13 and FIG. 14.

In the intermediate single mode waveguides 3a and 3b, in the case where the length Le was 0.25 cm, as shown in FIG. 13, when the voltages applied to the switching electrodes 6a and 6b were 0 (V), virtually all of the optical signal made incident from the input-side single mode waveguide 4a was emitted from the output-side single mode waveguide 5a—that is, channel 1—and virtually none of the optical signal was emitted from the output-side single mode waveguide 5b—that is, channel 2. When the voltages applied to the switching electrodes 6a and 6b were increased, the intensity of the optical signal emitted from channel 2 increased, and the intensity of the optical signal emitted from channel 1 decreased.

Then, when the voltages reached ±20 V, virtually all of the optical signal made incident from the input-side single mode waveguide 4a was emitted from channel 2. When the voltages exceeded ±20 V, the intensity of the optical signal emitted from channel 1 began to increase, and the intensity of the optical signal emitted from channel 2 began to decrease. From this result, it was understood that, in the intermediate single mode waveguides 3a and 3b, in the case where the length Le was 0.25 cm, the emission destination of the optical signal made incident from the input-side single mode waveguide 4a could be switched from the output-side single mode waveguide 5b to the output-side single mode waveguide 5a by changing the voltages applied to the switching electrodes 6a and 6b from 0 V to ±20V, and that the operating voltage Vs was 20 V.

On the other hand, in the intermediate single mode waveguides 3a and 3b, in the case where the length Le was 0.5 cm, as shown in FIG. 14, when the voltages applied to the switching electrodes 6a and 6b were 0 (V), virtually all of the optical signal made incident form the input-side single mode waveguide 4a was emitted from the output-side single mode waveguide 5a—that is, channel 1—and virtually none of the optical signal was emitted from the output-side single mode waveguide 5b—that is, channel 2. Then, when the voltages reached ±10 V, virtually all of the optical signal made incident from the input-side single mode waveguide 4a was emitted from channel 2.

When the voltages exceeded ±10 V, the intensity of the optical signal emitted from channel 1 began to increase, and the intensity of the optical signal emitted from channel 2 began to decrease. Then, when the voltages reached ±21 V, then again, the intensity of the optical signal emitted from channel 2 reached a minimum and the intensity of the optical signal emitted from channel 1 reached a maximum.

From this result, it was understood that, in the intermediate single mode waveguides 3a and 3b, in the case where the length Le was 0.5 cm, the emission destination of the optical signal made incident from the input-side single mode waveguide 4a could be switched from the output-side single mode waveguide 5b to the output-side single mode waveguide 5a by changing the voltages applied to the switching electrodes 6a and 6b from 0 V to ±10 V, and that the operating voltage Vs was 10 V.

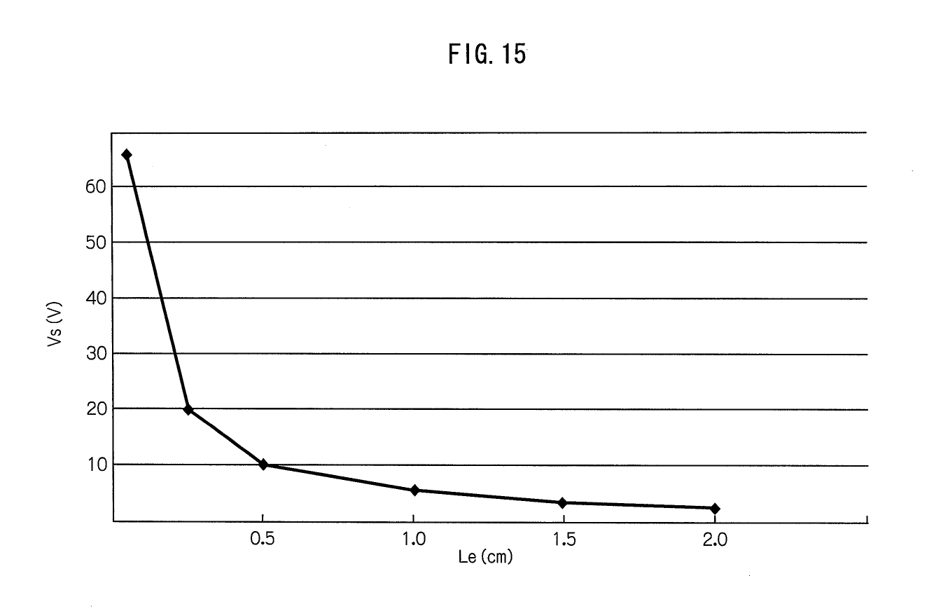

In this manner, in the waveguide device 102, it was understood that the drive voltage Vs became lower when the length Le of the portions of the intermediate single mode waveguides 3a and 3b covered by the switching electrodes 6a and 6b was 0.5 cm in comparison to when the length Le was 0.25 cm. The change in the drive voltage when the length Le was changed is shown in FIG. 15. As will be understood from FIG. 15, the drive voltage dropped the longer the length Le was. Specifically, when the length Le was 2 cm, the drive voltage Vs was only 2 V.

The waveguide device of the present invention can be used as an optical switch whose optical path is switched by an electrical signal and as a light modulation device where the intensity of an optical signal that passes through the inside thereof is changed by an electrical signal.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A waveguide device comprising:
a first multimode waveguide;
a second multimode waveguide;
a pair of intermediate single mode waveguides that interconnect the first multimode waveguide and the second multimode waveguide;
an input-side single mode waveguide that is connected to an end portion of the first multimode waveguide at a side opposite from a side to which the intermediate single mode waveguides are connected;
a pair of output-side single mode waveguides that are connected to an end portion of the second multimode waveguide at a side opposite from a side to which the intermediate single mode waveguides are connected;
a pair of switching electrodes that are disposed so as to be superposed on the pair of intermediate single mode waveguides; and
a ground electrode that is disposed at a side opposite from a side at which the switching electrodes are disposed,
the intermediate single mode waveguides being configured by a material having a refractive index that is changed by voltages applied to the switching electrodes,
the first multimode waveguide splitting an optical signal guided in from the input-side single mode waveguide into two signals having equal intensities, and
the second multimode waveguide being configured, when the voltages are not being applied to the switching electrodes, to guide optical signals propagated through the intermediate single mode waveguides out from the output-side single mode waveguides that are connected at positions diagonal to the intermediate single mode waveguides through which the optical signals are propagated.

2. The waveguide device of claim 1, wherein
the lengths of the first multimode waveguide and the second multimode waveguide in a width direction that is substantially orthogonal to the propagation direction of the optical signals are equal, and the length of the second multimode waveguide is twice the length of the first multimode waveguide in a direction that is substantially parallel to the propagation direction of the optical signals,
the input-side single mode waveguide is connected to a center portion of the end portion of the first multimode waveguide, and
the intermediate single mode waveguides and the output-side single mode waveguides are disposed substantially symmetrically with respect to a center axis along a length direction of the waveguide device.

3. The waveguide device of claim 1, wherein
the length and width of the first multimode waveguide is equal to the length and width of the second multimode waveguide,
two input-side single mode waveguides are provided, and
the two input-side single mode waveguides, the intermediate single mode waveguides and the output-side single mode waveguides are connected in the vicinity of a length direction side edge portion of the first multimode waveguide or the second multimode waveguide.

4. The waveguide device of claim 2, wherein when W₁ represents the width of the input-side single mode waveguide, the intermediate single mode waveguides and the output-side single mode waveguides, and W₂ represents the width of the first and second multimode waveguides, a relationship 2≦W₂/W₁≦100 is satisfied.

5. The waveguide device of claim 3, wherein when W₁ represents the width of the input-side single mode waveguide, the intermediate single mode waveguides and the output-side single mode waveguides, and W₂ represents the width of the first and second multimode waveguides, a relationship 2≦W₂/W₁≦100 is satisfied.

6. The waveguide device of claim 1, further comprising a core and a cladding that surrounds the core, wherein the first multimode waveguide, the second multimode waveguide, the intermediate single mode waveguides, the input-side single mode waveguide and the output-side single mode waveguides are formed by the core.

7. The waveguide device of claim 6, wherein the core has a rib structure that projects upward.

8. The waveguide device of claim 6, wherein the core has an inverted rib structure that projects downward.

9. The waveguide device of claim 2, wherein, when W₂ represents the width of the first and second multimode waveguides,
the intermediate single mode waveguides are disposed such that, at both end portions thereof respectively connected to the first multimode waveguide and the second multimode waveguide, the distance between centerlines of their cores is about W₂/2 and the respective distance from side edges of the first multimode waveguide and the second multimode waveguide to the centerlines of the cores is about W₂/4, and
the output-side single mode waveguides are disposed such that, at end portions thereof connected to the second multimode waveguide, the distance between centerlines of their cores is about W₂/2 and the respective distance from side edges of the second multimode waveguide to the centerlines of the cores is about W₂/4.

10. An optical network system comprising:
the waveguide device of claim 1;
a light-emitting component that causes an optical signal to be made incident on the input-side single mode waveguide of the waveguide device;
a light-receiving component that receives an optical signal from the output-side single mode waveguides of the waveguide device; and
a voltage application circuit that applies a voltage to an upper electrode of the waveguide device.

11. An optical network system comprising:
the waveguide device of claim 2;
a light-emitting component that causes an optical signal to be made incident on the input-side single mode waveguide of the waveguide device;
a light-receiving component that receives an optical signal from the output-side single mode waveguides of the waveguide device; and
a voltage application circuit that applies a voltage to an upper electrode of the waveguide device.

12. An optical network system comprising:
the waveguide device of claim 3;
a light-emitting component that causes an optical signal to be made incident on the input-side single mode waveguide of the waveguide device;
a light-receiving component that receives an optical signal from the output-side single mode waveguides of the waveguide device; and
a voltage application circuit that applies a voltage to an upper electrode of the waveguide device.
